(19) United States
(12) Patent Application Publication
(10) Pub. No.: US 2007/0217588 A1
(43) Pub. Date: Sep. 20, 2007

(54) Method for Distributing Software and Configuration Data With Time Monitoring, and Corresponding Data Network

(76) Inventor: Jean-Yves Bitterlich, Munchen (DE)

Correspondence Address: STAAS & HALSEY LLP, SUITE 700, 1201 NEW YORK AVENUE, N.W., WASHINGTON, DC, 20005, US

(21) Appl. No.: 11/664,128

(22) PCT Filed: Sep. 23, 2005
(86) PCT No.: PCT/EP05/54770

§ 371 Date: Mar. 29, 2007

(30) Foreign Application Priority Data
Sep. 29, 2004 (DE) 10 2004 047 367.6

(51) Int. Cl. H04M 3/42

(52) U.S. Cl. 379/201.03

(57) ABSTRACT

Distribution of software and configuration data is provided in data networks with a plurality of subscribers in a temporally defined manner. The software or data to be distributed is subdivided into data blocks and a corresponding list is generated. A first data block and the list are sent from a control centre to a first subscriber. Once a pre-determined length of time has passed following the reception of the list, the subscriber demands the missing data blocks from the control centre. The missing data blocks are then sent from the control centre to the subscriber such that the subscriber has a complete set of data blocks and can start an installation.

### CROSS REFERENCE TO RELATED APPLICATIONS

This application is based on and hereby claims priority to German Application No. 10 2004 047 367.6 filed on Sep. 29, 2004, the contents of which are hereby incorporated by reference.

### BACKGROUND

described below is a method for distributing software and/or configuration data in a data network having a plurality of subscribers and a corresponding data network having a plurality of subscribers and a central device for distributing the software or, as the case may be, configuration data.

Software management plays a central role for any mobile radio network operator. With several million subscribers, the operators are confronted by an enormous problem: How to change and update configurations for all terminals simultaneously or within a manageable timeframe. While the standardization bodies concentrate on the issue of how the updating and changing of configurations is to be managed on the network side and carried out on the terminal side, the question of how the operators are to handle the multiplicity of triggers and connections for the updates and changes is essentially left open.

### SUMMARY

An aspect is therefore to provide a method by which an update or, as the case may be, change of the configurations of a plurality of terminals can be carried out more easily. A corresponding data network is also specified.

Accordingly, a method for distributing software and/or configuration data in a data network having a plurality of subscribers includes subdividing a software package and/or configuration data package that is to be distributed into at least a first and a second data block, generating a list of all data blocks of the software package and/or configuration data package, sending the first data block and the list from a control center to a first of the plurality of subscribers, requesting the second data block by the first subscriber from the control center after a predefinable time or after a predefinable period of time has elapsed following the reception of the list, and sending the second data block from the control center to the first subscriber.

Also described below is a data network having at least a first and a second subscriber and a central device for distributing software and/or configuration data, wherein the software and/or configuration data to be distributed can be provided by the central device in at least a first and a second data block, a list of all data blocks of the software package and/or configuration data package can be provided by the central device, the first data block and the list can be transmitted to the first subscriber by the central device, a predefinable time or the expiration of a predefinable period of time after reception of the list can be specified by the first subscriber and, dependent thereon, at least the second data block can be requested from the central device by the first subscriber and the second data block can be transmitted directly by the control center to the first subscriber on request.

The advantage is that the installation or setup time can be substantially shortened by the proposed method or, as the case may be, the proposed data network. If a terminal or, as the case may be, a subscriber does not have all the data blocks after the predefined period of time, the terminal/subscriber (the pronoun “it” will henceforth be used synonymously for both) contacts a central management server to obtain the missing parts. As a result, the installation of new software, for example, can be completed for all subscribers within a manageable timeframe.

Preferably at least some of the subscribers are capable of forming an ad hoc network, so that a second subscriber can exchange at least one of the data blocks of the list with the first subscriber by spontaneous communication. In this way it is advantageously possible that the operators no longer have to trigger all the devices or, as the case may be, subscribers for the updates and changes of the configurations or, as the case may be, software. They must only send software or configuration data to a subset of subscribers. This saves energy and band-width, and hence money. Specifically, approximately a third of the distribution costs can be saved by subdividing the configuration data to be transmitted into data blocks compared with a standard P2P (Peer-to-Peer) software distribution method.

Since a subscriber does not receive the full set of data blocks for the configuration from the control center, it is informed by the list which data blocks it can receive from other subscribers by spontaneous communication, i.e. by a P2P connection or, as the case may be, an ad hoc network.

With spontaneous communication, the sending of the second data block by the second subscriber can be initiated at the request of the first subscriber. In this case the first subscriber, who is still missing the second data block, is the active part. It is particularly efficient in this case if the first subscriber issues its request on the basis of the list which it received from the control center to those subscribers that form an ad hoc network with it.

However, the sending of the second data block can also be initiated automatically by the second subscriber when it sets up the spontaneous communication or, as the case may be, the ad hoc network with the first subscriber. This means that in this case the second subscriber is the active part and the first subscriber has merely to decide whether it already has the second data block and if appropriate discards it.

The period of time for requesting the second data block can be predefined by the first subscriber. This enables each subscriber to determine for itself when at the latest it wants to have the installation or setup completed after reception of the list.

According to another variant, the remaining data block or blocks can also be requested by the first subscriber at the latest when the subscriber already has a predefined number or a predefined percentage of data blocks and the period of time has elapsed. In this way, for example, the majority of the data blocks can be distributed by spontaneous communication and the remainder by centralized dissemination via the data network.

Alternatively the period of time or the time for requesting the second data block can also be specified by the control center. It is beneficial in this case to transmit the period of time or the time together with the list. In this way the installation time can be fixed by the control center.

As soon as one of the plurality of subscribers has a full set of data blocks, an installation or setup can be started for the subscriber. The subscriber can independently ascertain on the basis of the list transmitted by the control center whether the set of data blocks is complete or not.

The spontaneous communication can be set up by Bluetooth or WLAN. Use can thus be made of known standards.

### BRIEF DESCRIPTION OF THE DRAWINGS

These and other objects and advantages will become more apparent and more readily appreciated from the following description of the exemplary embodiment, taken in conjunction with the accompanying drawing, which schematically depicts a data network.

### DETAILED DESCRIPTION OF THE PREFERRED EMBODIMENT

The solution is based on a P2P software management distribution principle with part delivery. In this scheme large volumes of data that are necessary for updating or changing the software or, as the case may be, configuration are divided into blocks which are then sent to “selected” devices. For this purpose only one data block is sent to a device in each case.

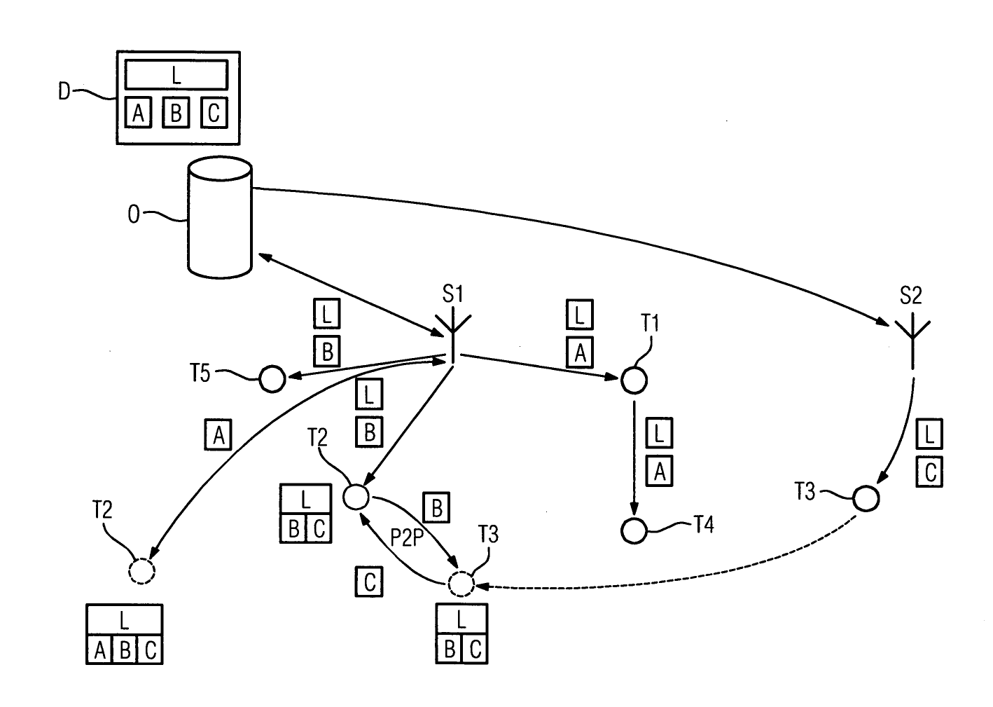

In the example in FIG. 1 the operator O provides a data set D by which the subscribers T1, T2 and T3 of a mobile radio network are to be reconfigured. In this case the data of the data set D is subdivided into blocks A, B and C. In addition the data set D possesses a list L which contains a script detailing all the data blocks A, B and C that are to be received by the subscribers.

The operator O now sends the individual data blocks A, B and C together with the list L via transmitting stations S1 and S2 to the subscribers T1, T2 and T3. The subscriber T5 is also supplied by the transmitting station S1.

In the concrete example the transmitting station S1 sends a data block A including the list L to the subscriber T1. The transmitting station S1 also sends a data block B including the list L to a subscriber T2. The other transmitting station S2 sends a data block C including the list L to a subscriber T3. The limiting to a small number of subscribers and transmitting stations is chosen here purely arbitrarily. Fundamentally the number of transmitting stations and subscribers can be chosen arbitrarily high.

The transmitting station S1 also transmits the data block B including the list L to a subscriber T5. By way of spontaneous communication the subscriber T1 also sends the data block A received together with list L from the transmitting station S1 onward to a subscriber T4. In this way the data can be relayed not only via the transmitting stations S1 and S2, but also, analogously to the principle by which viruses spread, among the subscribers themselves.

Since the subscribers that received new data also received a list L which provides information about all the necessary data blocks, the subscribers also know which data blocks they are still missing. However, in order not to load the data network unnecessarily with the forwarding of configuration data, an additional dissemination mechanism is provided. If, that is, one subscriber moves toward another (in the example in the drawing the subscriber T3 moves toward the subscriber T2), the two, if they are suitably close to each other, can set up an ad hoc network or, as the case may be, a P2P connection via Bluetooth or WLAN. The configuration data blocks can then be exchanged via this communication connection. In the present case the subscriber T2 sends the data block B to the subscriber T3 and the subscriber T3 sends the data block C to the subscriber T2. This takes place either by the subscriber T3 automatically sending off the data block C when a P2P connection has been set up to another subscriber. In the same way the subscriber T2 could automatically send off the data block B when the P2P connection has been set up to another subscriber.

Alternatively each subscriber can use the list L, since with it they know which data blocks they are still missing for the complete configuration data set. In the present example this would mean that the subscriber T2 inquires of the subscriber T3 whether the latter has the data block A or C. Since the subscriber T3 possesses the data block C, the subscriber T3 sends the data block C to the subscriber T2. The same applies to the transmission of the data block B from the subscriber T2 to the subscriber T3. Finally both subscribers T2 and T3 each have both data blocks B and C. It is then simply necessary to wait until one of the subscribers T2 and T3 comes into contact with the subscriber T1 or T4, so that the subscriber can receive the remaining data block A.

Owing to this virus-like dissemination of data blocks for the configuration or other software updates, less load is placed on the data network, with the result that less bandwidth is required for software management. The transmission of data blocks is instead guaranteed by ad hoc connections between the devices. This principle is economically of interest in particular when there are large volumes of data requiring to be distributed.

To ensure that the distribution of the data blocks does not last for an indefinitely long time, but instead that a full set of data blocks is available to each subscriber after a specific time, the data distribution is subject to time monitoring. This is realized for example in that a predefinable period of time is stored in the respective subscriber. After this period of time has elapsed, following the reception of the list L the subscriber must contact the operator O to request the remaining data blocks from it directly. In the concrete example in the drawing the subscriber T2 still does not have the data block A at the end of the specified time. It knows from the list L that it is still missing the data block A. It therefore contacts the operator O via the transmitting station S1. The operator O thereupon sends the missing data block A to the subscriber T2. The subscriber T2 thus has a full data set and can start the installation.

The predefined period of time after which a subscriber contacts the operator O or, as the case may be, the corresponding control center after reception of the list L can be permanently preprogrammed in the terminal or, as the case may be, subscriber. Alternatively the period of time can also be transmitted by the operator O to the respective subscriber in a script containing the list L. In this case the period of time, e.g. five days, can be fixed. Alternatively a time, e.g. November 1, can be specified as the “period of time”.

According to another variant it can be stipulated that the subscriber must request the remaining data blocks when it already has a minimum number of data blocks. In this case it must for example contact the operator O when, for example, it already possesses 60% of the required data blocks.

A combination of these request conditions can also be favorable in the real-world case. Thus, for example, a request can be initiated when the subscriber already has 60% of the required data blocks, but has not received the missing data blocks from other subscribers within the last five days.

To request the remaining data blocks the subscriber or, as the case may be, the terminal contacts a special server URL. It thereupon receives the missing data block or blocks directly from the operator O, possibly also from another subscriber, via the data network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-16. (canceled)

17. A method for distributing software or configuration data in a data network having a plurality of subscribers, comprising:
subdividing at least one of a software package and a configuration data package to be distributed into at least first and second data blocks;
generating a list of all data blocks of the at least one of the software package and the configuration data package;
sending the first data block and the list from a control center to a first subscriber;
requesting the second data block by the first subscriber from the control center after one of a predefined time and a predefined period of time following reception of the list; and
sending the second data block from the control center to the first subscriber in response to said requesting.

18. The method as claimed in claim 17, wherein at least some of the subscribers are ad hoc network capable and a second subscriber exchanges at least one of the data blocks in the list with the first subscriber by spontaneous communication.

19. The method as claimed in claim 18, wherein the predefined period of time for requesting the second data block is specified by the first subscriber.

20. The method as claimed in claim 19, wherein each remaining data block is requested by the first subscriber no later than when the first subscriber has one of a predefined number and a predefined percentage of the data blocks in the list and the predefined period of time has elapsed.

21. The method as claimed in claim 18, wherein the one of the predefined period of time and the predefined time for requesting the second data block is specified by the control center.

22. The method as claimed in claim 21, wherein the predefined period of time is transmitted together with the list.

23. The method as claimed in claim 22, further comprising starting at least one of an installation and a setup when one of the plurality of subscribers has all of the data blocks in the list.

24. The method as claimed in claim 23, wherein the spontaneous communication is set up by Bluetooth or WLAN.

25. A data network, comprising:
at least first and second subscriber devices; and
a central device distributing at least one of software and configuration data in at least first and second data blocks, together with a list of all data blocks of the at least one of the software and the configuration data, the first data block and the list being transmitted by the central device to the first subscriber device and at a predefined time or after a predefined period of time following reception of the list, the first subscriber requests at least the second data block from the central device which transmits the second data block directly from the control center to the first subscriber.

26. The data network as claimed in claim 25, wherein at least some of said subscriber devices are ad hoc network capable.

27. The data network as claimed in claim 26, wherein the predefined period of time for requesting the second data block is specified by said first subscriber device.

28. The data network as claimed in claim 27, wherein the first subscriber device determines the predefined time based on a number of the data blocks in the list that said first subscriber device has received.

29. The data network as claimed in claim 26, wherein the one of the predefined time and the predefined period of time is specified by said control center.

30. The data network as claimed in claim 29, wherein the one of the predefined time and the predefined period of time is transmitted with the list.

31. The data network as claimed in claim 30, wherein one of said subscribers automatically starts one of installation and setup upon completing reception of all of the data blocks in the list.

32. The data network as claimed in claim 31, wherein one of said subscriber devices initiates spontaneous communication between the subscribers by one of Bluetooth and WLAN.
